(19) United States
(12) Patent Application Publication
(10) Pub. No.: US 2006/0117074 A1
(43) Pub. Date: Jun. 1, 2006

(54) Method and apparatus for database cluster recovery

(76) Inventor: Ahmed K. Ezzat, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/000,467

(22) Filed: Nov. 30, 2004

(51) Int. Cl. G06F 17/30

(52) U.S. Cl. 707/202

(57) ABSTRACT

A disclosed method includes maintaining redo log blocks in a disk array cache and filtering the redo log records using a data block written flag (DBWF), and generating a recovery set that in the disk array cache that is a subset of redo log records generated by a failed database instance. A database cluster providing database cluster recovery is also disclosed.

### BACKGROUND

A database cluster includes a group of independent servers coupled together via a local area network (LAN) employing a shared disk architecture. The database cluster will use a separate high-speed interconnect between processes running on the different servers to exchange data and for cache synchronization. An example of such a database cluster is the Oracle real application cluster (RAC). Every time an Oracle instance is started in a RAC database cluster, a memory area called the system global area (SGA) is allocated and a set of background processes are started. The combination of the SGA and the processes is called an Oracle database instance or simply an instance. The RAC consists of multiple instances with each instance residing on an individual node (single server or symmetric multiprocessing (SMP) system, etc.). The memory and processes of an instance work to manage the database's data efficiently and serve the one or multiple users associated with that instance of the database. A RAC is a set of Oracle instances that cooperate together to provide a scalable solution for workload that can not be met with a single node Oracle database instance. A node in the RAC can be either a single central processing unit (CPU) or an SMP running a single instance. RAC can have different types of failure and as a result RAC can support different types of RAC recovery including media recovery as well as instance recovery.

A database instance failure can be caused by a number of things such as the database has taken the instance down, the server has been shut down, the server has rebooted and the instance has not been sent to auto-start, etc. When an instance failure occurs, the Oracle instance recovery process can automatically recover the database upon instance startup. Transactions that were committed when the failure occurred are recovered or rolled forward and all transactions that were currently in process are rolled back.

Cache fusion architecture within the RAC architecture provides improved scalability by “virtualizing” the sum of the different instances' local buffer caches into one virtual large cache available to the whole RAC system in order to satisfy application requests. Cache fusion uses a high-speed interconnect (e.g., Gigabit Ethernet, etc.) for transferring blocks of data between the instances' local buffer cache using interprocess communication (IPC). Cache fusion provides consistency of data blocks in multiple instances, by treating multiple buffer caches as one joint global cache without any impact on the application code or design.

A global cache service (GCS) is introduced by the cache fusion and is implemented as a set of processes that include a lock manager server process (LMSn) that are instance processes for GCS, and the global enqueue daemon (LMD) is a lock agent process for GES that coordinates enqueue manger service requests. The GCS and GES maintain a global resource directory (GRD) to record information about resources (data blocks) and enqueues. GRD remains in memory, and a portion of the directory resources are managed by every instance in the RAC. The GCS requires an instance to acquire a cluster-wide resource before a data block can be modified or read, with the resource being an enqueue and/or lock.

With a multi-node RAC, data blocks may exist in any of the instances, or any instance may fetch the data blocks as needed by the user application. Cache fusion plays a key role in maintaining consistency among the cached versions of the data blocks in multiple instances. When an instance needs to access a data block it can figure out through a local operation which instance (LMS) in the RAC is managing that data block. This replicated data is relatively static data, and only needs to change when an instance fails and the relevant data blocks managed by the failed instance need to be assigned to the remaining instance in the RAC.

### BRIEF DESCRIPTION OF THE DRAWINGS

For a detailed description of exemplary embodiments of the invention, reference will now be made to the accompanying drawings in which:

FIG. 1 shows a flowchart highlighting a database cluster recovery flow in accordance with an embodiment of the invention;

FIG. 2 shows a block diagram of a database cluster in accordance with an embodiment of the invention; and

FIG. 3 shows a flowchart highlighting a first phase of instance recovery in accordance with an embodiment of the invention.

### NOTATION AND NOMENCLATURE

Certain term(s) are used throughout the following description and claims to refer to particular system components. As one skilled in the art will appreciate, different companies/industries may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

By leveraging the large cache and processing power available in a disk array storage subsystem, the embodiments of the present invention help improve server instance recovery. Such functionality results in reducing the time during which the database is not accessible for applications (phase one of recovery previously discussed), thereby increasing the overall database availability. In one embodiment, a disk array such as for an Oracle RAC is provided that provides the improved instance recovery. Embodiments of the present invention can be used with any database cluster or disk array that has suitable cache and processing power.

A redo log record includes multiple fields including timestamp, disk block address (DBA), Data Block Written Flag (DBWF), etc. The redo log record records all changes made to the database cluster. When the DBWF is set it indicates that all earlier redo log records for the same DBA are not needed as far as instance recovery is concerned, this process is referred to as “filtering.” The net effect of scanning all redo log records and performing the filtering is producing the recovery set.

For illustrative purposes, an example of a database cluster includes one hundred blocks and a few instances. For recovery illustration purposes, we will focus only on the runtime behavior of only one instance, referred here as instance-1 which is part of the database cluster that is executing a given application. In this example, instance-1 has done the following operations:
Read and then updated block DBA₁ which generated redo log record₁
Read and then updated block DBA₂ which generated redo log record₂
Read and then updated block DBA₃ which generated redo log record₃
Update block DBA₁ and write the updated block to disk and generate redo log record₄ with the DBWF flag set (BWR flag in the case of an Oracle RAC system).
   During instance recovery, i.e., after instance-1 failure, the elected surviving instance (say instance-2) will read the redo log for instance-1, which includes record₁, record₂, record₃ and record₄. On reading redo log record₄ with the DBWF flag set, both record₄ as well as all earlier redo log records that belong to DBA₁ (i.e., record₁ in the above example) will be tossed away. The process of scanning the redo log records and throwing away the appropriate records is called “filtering.” The “recovery set” at this point in time is two redo log records (record₂, record₃). At the end of phase one, the database is available to applications except the blocks (DBA) that are members of the “recovery set.” In phase two of the recovery, the recovery instance will apply the redo log records in the “recovery set” to the database and as a result, recover the state of the database as of the time when the failure occurred. On completing phase two, the database is fully available to applications in the database cluster. Phase one of the recovery where the entire database cluster is not available takes on the order of 10% of the total instance recovery time, and may typically range from 3 minutes to 3 hours. Phase two of the recovery on the other hand can take a very long time.

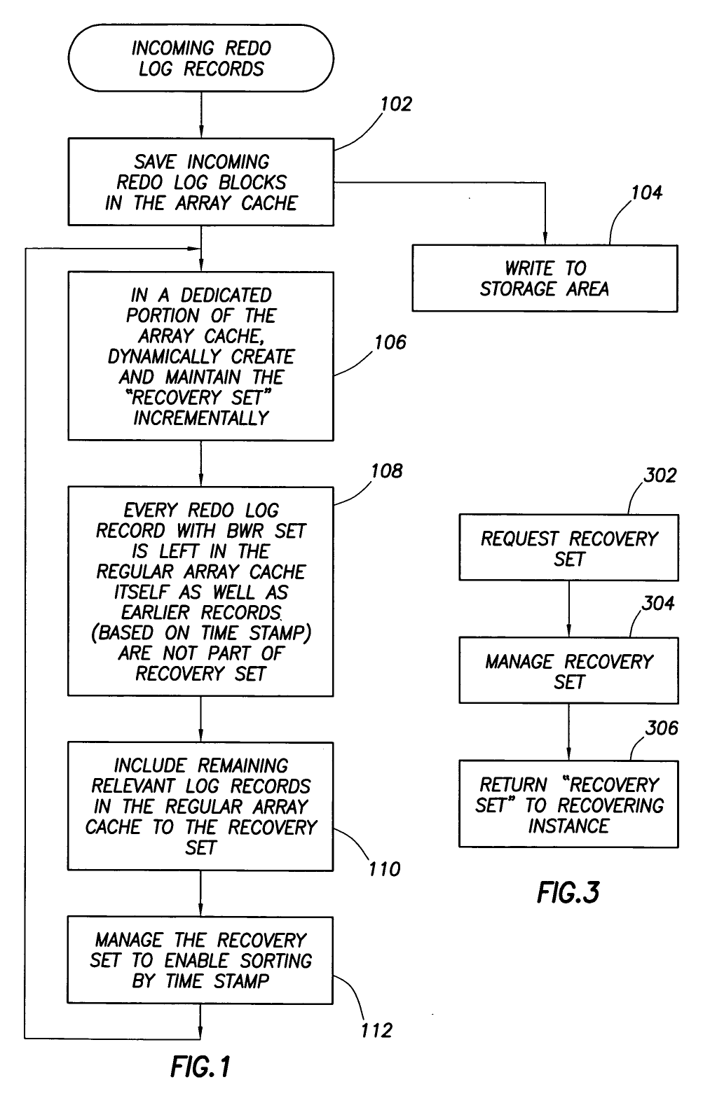

Referring to FIG. 1, there is shown a flow diagram highlighting a database cluster recovery technique in accordance with an embodiment of the invention. In 102, incoming redo log blocks are saved and processed in a disk array cache. These blocks will also be written to a stable storage area as is usual in 104. In 106, preferably as a background operation, the array processors will generate and maintain dynamically the “recovery set” in a separate area in the disk array cache incrementally. The generation of this “recovery set” does not imply physical copy of the redo log records themselves. The “recovery set” can be generated by having the array processor(s) scan redo log blocks for records that have a Data Block Written Flag (DBWF) set. A DBWF field is set in the redo log buffer when an instance writes or discards a block covered by a global resource. In the case of the Oracle environment, the DBWF filed corresponds to the Block Written Record (BWR) field. This helps filter the redo logs coming from the instance. In one embodiment, every redo log record with the DBWF set is left in the regular array cache, the redo log record as well as earlier records (based on time stamp information) are not part of the recovery set.

All records having a time stamp that is earlier than the value for the record with the DBWF field (e.g., BWR) set will not be part of the recovery set, only the remaining redo log records will be part of the recovery set while all redo log records are included in the regular disk array cache in 110. In the case of an Oracle environment, the time stamp can comprise a system change number (SCN). Redo log records that are part of the recovery set will be managed by data structures that enable sorting them by their timestamp and enable returning the sorted “recovery set” back to the instance on demand in 112. The routine then loops back to step 106.

One implementation includes creating a header data structure per every redo log record in the recovery set. These header data structures can be inserted into a hash table based on their disk block address (DBA). In this way, the record can be accessed and be possibly removed from the “recovery set” later on. Added to every header can be a link to enable linking these headers to reflect sorted redo log records based on their timestamp (e.g., Oracle SCN). On demand of the “recovery set,” the disk array returns the “recovery set” back to the instance sorted by SCN by traversing the linked list using the above mentioned link.

Whenever an instance failure happens, the elected “recovery instance” would request the “recovery set” instead of the entire redo log for that failed instance. This has one or more of the following potential positive effects towards reducing elapsed time, during which the database is not accessible by applications: it reduces the amount of data that needs to be sent back from the storage array to the Oracle recovery instance from a few Giga-bytes (GBs) to a few Mega-bytes (MBs); returning a few MBs of data rather than a few GBs has significant impact on reducing paging in the recovering instance, which in turn has significant impact on phase one recovery time; the disk array cache provides optionally for a unique opportunity to function as a shared memory for the redo logs for the different threads/instance in the RAC, the processor(s) can further eliminate not needed redo log entries, in turn further reducing the size of the “recovery set”; it saves the processing time needed by the recovery instance processor to create the “recovery set” which helps reduce the time during which the database is not accessible; and it provides a chance to sort or merge/sort redo logs based on the timestamp (e.g., SCN value), in order for this to be effective, the (e.g., Oracle) “recovery instance” needs to know that the returned redo log records have been sorted already, otherwise, the “recovery instance” will sort them again, which will be a “NOOP” operation (no operation).

The Oracle instance writes its redo log records to the redo log device on the disk array. Production systems are typically configured with low array utilization (e.g., below 50% utilization), which means that there is plenty of processing cycles to execute the proposed algorithm. While the filtering and sorting routine discussed above is generally performed in real-time while data is getting in the disk array cache, it can also be performed in non-real-time or near real-time. While it is expected that CPU cycle availability in the disk array will not be an issue, scheduling these cycles should be carefully handled to ensure optimum performance. Processing incoming redo logs, as the normal operation of the disk array, should take precedence over executing the filtering/sorting operations to avoid impacting the normal redo log operation's performance. As such, it is desirable to be able to perform the filtering/sorting in the background while the disk array cycles are idle. An alternative to the above approach is to have a general purpose CPU(s) dedicated to filtering/sorting the redo log records, and running a general purpose OS instead of performing these operations by the traditional disk array CPUs which typically run a real-time OS.

In a single instance failure, the redo log records can optionally be kept permanently in the disk array cache, eliminating the redo log records associated with blocks that have been written already to disk, for example using the DBWF flag. As a result, only a subset of the redo log records can be returned. There is no reason to return the entire redo log record over the network to discover later that most were not required. As a result, the size of the recovery set has been reduced and is smaller than the size of the entire redo log. The resources in the recovery set include the set of blocks that have been modified in the failed set but not written yet to the disk by the failed instance.

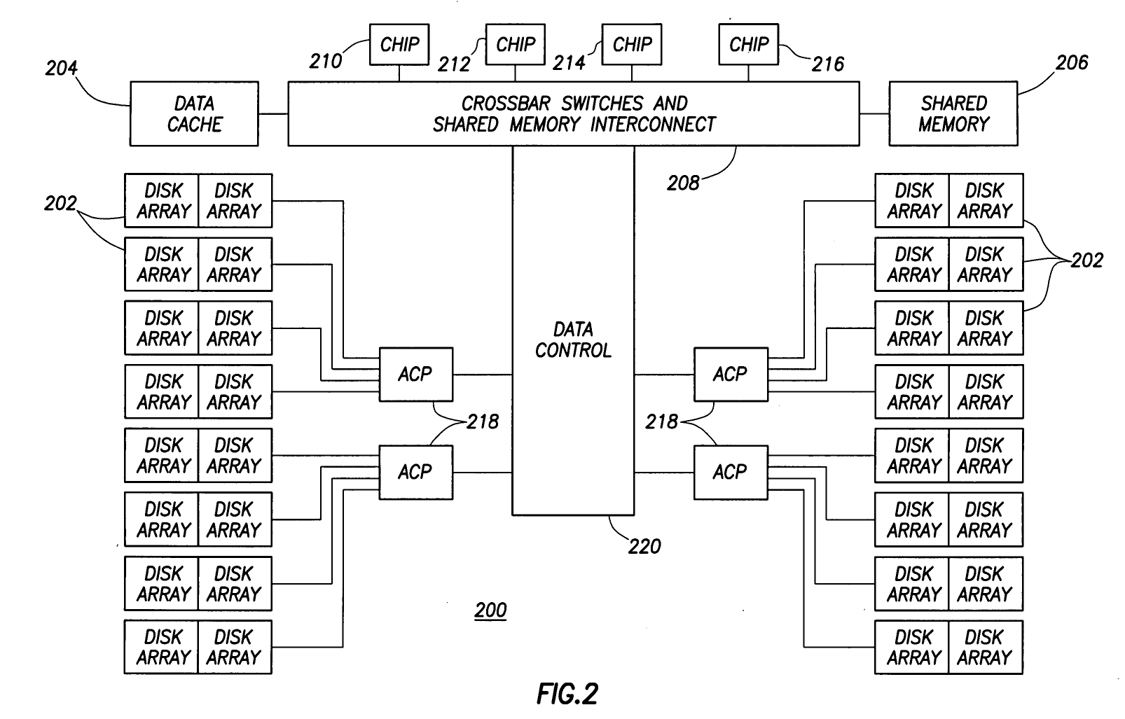

Referring now to FIG. 2, there is shown a disk array 200 in accordance with an embodiment of the invention. In one embodiment, disk array 200 can comprise a Hewlett-Packard, Inc. (HP) StorageWorks Disk Array XP such as a HP SureStore E XP family disk array that includes the database cluster recovery routine discussed herein. It should be noted that the embodiments of the present invention can be used with many types of disk arrays and the disclosed embodiment is simply for illustrative purposes.

The disk array includes a plurality of disk storage arrays 202, a data cache 204, a shared memory 206, crossbar switches/shared memory interconnect 208, up to four chip host interface processors (CHIP) pairs 210-216, a plurality of array control processors (ACPs) 218 having direct access to both the data cache 202, shared memory 206 as well as to the disk storage arrays 202 through a fiber channel. The CHIPs 210-216 provide a connection point for host connectivity to the array 200. The CHIPs 210-216 send commands and signals to the ACPs 218 to read/write cache memory to or from disks. Additional CHIP functions are to access and update the cache track directory; monitor data access patterns, emulate host device types, and provide a connectivity point for array-to-array replication. A data control block 220 provides for interconnection between the ACPs 218 and the crossbar switch/shared memory interconnect 208.

In an embodiment of the invention, the disk array cache 204 provides a unique opportunity to function as shared memory for the redo logs for the different threads/instances in the database cluster. The CHIP's CPU can further eliminate unneeded redo log entries, and in turn further reduce the size of the “recovery set.” The reduction of the recovery set helps reduce the time the database is not accessible by applications and the amount of data traffic over the network. While redo log records are being generated by an instance, the CHIP processors 210-216 can execute asynchronously the cluster recovery technique as discussed previously.

Embodiments of the present invention also provide the opportunity to sort or merge/sort the redo logs based on a time stamp such as by using the SCN value. In case of an Oracle environment, the Oracle recovery instance needs to know that the returned redo log records have been sorted already, otherwise the Oracle recovery instance will sort them again.

In FIG. 3, there is shown the first phase of instance recovery in accordance with an embodiment of the invention. In 302, a request is made by the recovery instance to get the “recovery set” from the disk array. In step 304, the recovery set is managed by the disk array CPUs to filter/sort the redo log records by their time stamp. In step 306, the “recovery set” is returned to the recovery instance. As an illustrative example in an Oracle environment, the recovery set is returned to the recovering Oracle instance.

Moving some recovery functions to an intelligent store such as a disk array cache as done in the present invention will help reduce the recovery time during the time the database is not accessible and help provide improved database availability. The method and apparatus presented in this disclosure is applicable to other database functions, and in general to functions that require sort and/or search capabilities. Moving such functions to an intelligent disk array can be very beneficial from a performance point of view.

The above discussion is meant to be illustrative of the principles and various embodiments of the present invention. Numerous variations and modifications will become apparent to those skilled in the art once the above disclosure is fully appreciated.

What is claimed is:

1. A method, comprising:
maintaining redo log blocks in a disk array cache;
filtering the redo log blocks using a data block written flag (DBWF); and
generating a recovery set in the disk array cache that is a subset of redo log records generated by a failed database instance.

2. A method as defined in claim 1, wherein the DBWF comprises a block written record (BWR) field.

3. A method as defined in claim 1, further comprising:
sorting the redo log records by their timestamp within the disk array cache.

4. A method as defined in claim 3, further comprising:
returning the sorted recovery set back on demand to the recovering failed database instance.

5. A method as defined in claim 3, wherein sorting the redo log records by their timestamp comprises sorting the redo log records using a system change number (SCN).

6. A method as defined in claim 1, further comprising:
storing the recovery set in a separate area in the disk array cache than where the redo log blocks are stored.

7. A method as defined in claim 1, further comprising:
creating a header data structure for every redo log record in the recovery set to avoid physical copying of the redo log records in the disk array cache.

8. A method as defined in claim 7, further comprising:
placing the header data structures in a hash table.

9. A method as defined in claim 8, further comprising:
placing the header data structures in the hash table based on their disk block address (DBA).

10. A method as defined in claim 7, further comprising:
adding a link to every header data structure in order to enable linking the header data structures to reflect sorted redo log records based on their timestamp.

11. A database cluster providing database cluster recovery, comprising:
a disk array;
a disk array cache coupled to the disk array;
a disk array controller for saving redo log blocks in the disk array cache, for filtering the redo log records using data block written flag (DBWF) fields, and providing a small subset of the redo log blocks representing a recovery set in the disk array cache.

12. A database cluster as defined in claim 11, wherein the disk array controller sorts the redo log blocks by their time stamps.

13. A database cluster as defined in claim 12, wherein the recovery set is stored in a separate area in the disk array cache than where the redo log blocks are stored.

14. A database cluster as defined in claim 11, wherein the disk array controller dynamically creates and maintains the recovery set.

15. A database cluster as defined in claim 11, wherein the disk array controller includes data structures for managing the redo log records that are part of the recovery set.

16. A method for database cluster recovery, comprising:
maintaining redo log blocks in a disk array cache;
filtering the redo log blocks using a block written record (BWR) field;
generating a recovery set in a disk array cache which is a subset of redo log records generated by a failed database instance; and
sorting the redo log records using timestamp information within the disk array cache.

17. A method as defined in claim 16, wherein sorting the redo log records using timestamp information comprises using system change numbers (SCN) to sort the redo log records.

18. A method as defined in claim 17, further comprising:
returning the recovery set sorted by SCN to a database instance on demand.

19. A method as defined in claim 18, further comprising:
filtering further the redo log records by checking against the redo log records of other instances.
